(19) United States
(12) Patent Application Publication
(10) Pub. No.: US 2023/0236984 A1
(43) Pub. Date: Jul. 27, 2023

(54) MEMORY BUILT-IN DEVICE, PROCESSING METHOD, PARAMETER SETTING METHOD, AND IMAGE SENSOR DEVICE

(71) Applicant: Sony Group Corporation, Tokyo (JP)

(72) Inventors: Hiroyuki KATCHI, Tokyo (JP); Mamun KAZI, Tokyo (JP)

(73) Assignee: Sony Group Corporation, Tokyo (JP)

(21) Appl. No.: 17/999,564

(22) PCT Filed: May 21, 2021
(86) PCT No.: PCT/JP2021/019474

§ 371 Date: Nov. 22, 2022

(30) Foreign Application Priority Data
May 29, 2020 (JP) 2020-094935

(51) Int. Cl. G06F 12/0875; G06F 12/0877; G06F 17/16

(52) U.S. Cl. CPC G06F 12/0875; G06F 12/0877; G06F 17/16; G06F 2212/452

(57) ABSTRACT

A memory built-in device according to the present disclosure is a memory built-in device including a processor; a memory access controller; and a memory to be accessed in accordance with a process by the memory access controller, wherein the memory access controller is configured to read and write data to be used in an operation of a convolution arithmetic circuit from and to the memory according to designation of a parameter.

### FIELD

The present disclosure relates to a memory built-in device, a processing method, a parameter setting method, and an image sensor device.

### BACKGROUND

In an AI technology such as a neural network, access to a memory increases because enormous computation is performed. For example, a technique for accessing an N-dimension tensor has been provided (Patent Literature 1).

### CITATION LIST

### Patent Literature

Patent Literature 1: JP 2017-138964 A

### SUMMARY

### Technical Problem

According to the related art, by preparing dedicated hardware that executes only a command corresponding to address calculation (generation) and address calculation, part of processing is offloaded to hardware.

However, in the foregoing prior art, for address calculation, the CPU is required to issue a dedicated command each time, and there is room for improvement. Therefore, it is desired to enable appropriate access to the memory.

Therefore, the present disclosure proposes a memory built-in device, a processing method, a parameter setting method, and an image sensor device capable of enabling an appropriate access to a memory.

### Solution to Problem

According to the present disclosure, a memory built-in device includes a processor; a memory access controller; and a memory to be accessed in accordance with a process by the memory access controller, wherein the memory access controller is configured to read and write data to be used in an operation of a convolution arithmetic circuit from and to the memory according to designation of a parameter.

### BRIEF DESCRIPTION OF DRAWINGS

FIG. 1 is a diagram illustrating an example of a processing system of the present disclosure.

FIG. 2 is a diagram illustrating an example of a hierarchical structure of a memory.

FIG. 3 is a diagram illustrating an example of dimensions used for a convolution operation.

FIG. 4 is a conceptual diagram illustrating a convolution process.

FIG. 5 is a diagram illustrating an example of storing tensor data in a cache memory.

FIG. 6 is a diagram illustrating an example of a convolution operation program and abstraction thereof.

FIG. 7 is a diagram illustrating an example of address calculation when an element of a tensor is accessed.

FIG. 8 is a conceptual diagram according to a first embodiment.

FIG. 9 is a diagram illustrating an example of a process according to the first embodiment.

FIG. 10 is a diagram illustrating an example of a process according to the first embodiment.

FIG. 11 is a flowchart illustrating a procedure of processing according to the first embodiment.

FIG. 12 is a diagram illustrating an example of a memory access according to the first embodiment.

FIG. 13 is a diagram illustrating a modification according to the first embodiment.

FIG. 14 is a diagram illustrating an example of a configuration of a cache line.

FIG. 15 is a diagram illustrating an example of hit determination regarding a cache line.

FIG. 16 is a diagram illustrating an example of initial setting in a case of performing CNN processing.

FIG. 17A is a diagram illustrating an example of address generation according to a second embodiment.

FIG. 17B is a diagram illustrating an example of address generation according to the second embodiment.

FIG. 18 is a diagram illustrating an example of a memory access controller.

FIG. 19 is a flowchart illustrating a procedure of processing according to the second embodiment.

FIG. 20 is a diagram illustrating an example of a process according to the second embodiment.

FIG. 21 is a diagram illustrating an example of a memory access according to the second embodiment.

FIG. 22 is a diagram illustrating another example of a process according to the second embodiment.

FIG. 23 is a diagram illustrating another example of the memory access according to the second embodiment.

FIG. 24 is a diagram illustrating an example of application to a memory stacked image sensor device.

### DESCRIPTION OF EMBODIMENTS

Hereinafter, the embodiments of the present disclosure will be described in detail with reference to the drawings. Note that the memory built-in device, the processing method, the parameter setting method, and the image sensor device according to the present application are not limited by the embodiment. In the following embodiments, the same parts are denoted by the same reference signs, and a duplicate description will be omitted.

The present disclosure will be described in the order of the following items.

### 1. Embodiment

1-1. Outline of Processing System According to Embodiment of Present Disclosure

1-2. Overall Overview and Problems

1-3. First Embodiment
1-3-1. Modification

1-4. Second Embodiment
1-4-1. Premise, and the Like

### 2. OTHER EMBODIMENTS

2-1. Other Configuration Examples (Image Sensor and the Like)

2-2. Others

### 3. Effects According to the Present Disclosure

### 1. Embodiment

[1-1. Overview of Processing System According to Embodiment of Present Disclosure]

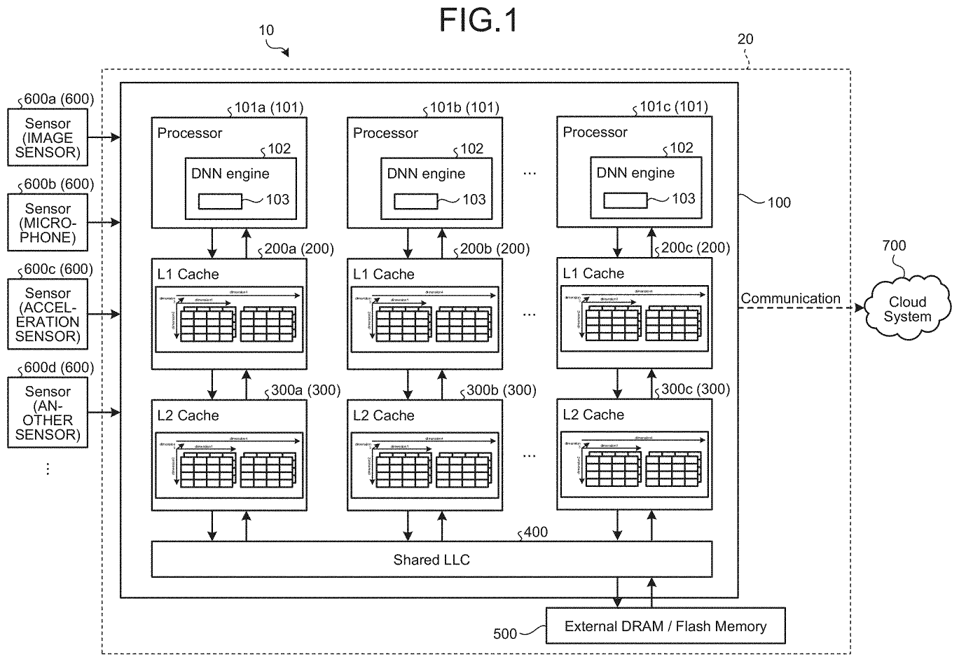

FIG. 1 is a diagram illustrating an example of a processing system according to an embodiment of the present disclosure. As illustrated in FIG. 1, a processing system 10 includes a memory built-in device 20, a plurality of sensors 600, and a cloud system 700. Note that the processing system 10 illustrated in FIG. 1 may include a plurality of the memory built-in devices 20 and a plurality of the cloud systems 700.

The plurality of sensors 600 includes various sensors such as an image sensor 600a, a microphone 600b, an acceleration sensor 600c, and another sensor 600d. Note that the image sensor 600a, the microphone 600b, the acceleration sensor 600c, the another sensor 600d, and the like are referred to as a “sensor 600” in a case where they are not particularly distinguished from one another. The sensor 600 is not limited to the above sensors, and may include various sensors such as a position sensor, a temperature sensor, a humidity sensor, an illuminance sensor, a pressure sensor, a proximity sensor, and a sensor that detects biometric information such as odor, sweat, heartbeat, pulse, and brain waves. For example, each sensor 600 transmits detected data to the memory built-in device 20.

The cloud system 700 includes a server device (computer) used to provide a cloud service. The cloud system 700 communicates with the memory built-in device 20 to transmit and receive information to and from the remote memory built-in device 20.

The memory built-in device 20 is communicably connected to the sensor 600 and the cloud system 700 in a wired or wireless manner via a communication network (for example, the Internet). The memory built-in device 20 includes a communication processor (network processor), and communicates with external devices such as the sensor 600 and the cloud system 700 via a communication network by the communication processor. The memory built-in device 20 transmits and receives information to and from the sensor 600, the cloud system 700, and the like via a communication network. Furthermore, the memory built-in device 20 and the sensor 600 may communicate with each other by a wireless communication function such as wireless fidelity (Wi-Fi) (registered trademark), Bluetooth (registered trademark), a long term evolution (LTE), a fifth generation mobile communication system (5G), or a low power wide area (LPWA).

The memory built-in device 20 includes an arithmetic device 100 and a memory 500.

The arithmetic device 100 is a computer (information processing device) that executes arithmetic processing related to machine learning. For example, the arithmetic device 100 is used to calculate a function of artificial intelligence (AI). The functions of the artificial intelligence are, for example, learning based on learning data, inference based on input data, recognition, classification, data generation, and the like, but are not limited thereto. In addition, the function of the artificial intelligence uses a deep neural network. That is, in the example of FIG. 1, the processing system 10 is an artificial intelligence system (AI system) that performs processing related to artificial intelligence. The memory built-in device 20 performs a deep neural network (DNN) process for inputs from the plurality of sensors 600.

The arithmetic device 100 includes a plurality of processors 101, a plurality of first cache memories 200, a plurality of second cache memories 300, and a third cache memory 400.

The plurality of processors 101 includes a processor 101a, a processor 101b, a processor 101c, and the like. Note that the processors 101a to 101c and the like will be referred to as a “processor 101” in a case where they are described without being particularly distinguished. Note that, in the example of FIG. 1, three processors 101 are illustrated, but the number of processors 101 may be four or more, or may be less than three.

The processor 101 may be various processors such as a central processing unit (CPU) and a graphics processing unit (GPU). Note that the processor 101 is not limited to the CPU and the GPU, and may have any configuration as long as it is applicable to arithmetic processing. In the example of FIG. 1, the processor 101 includes a convolution arithmetic circuit 102 and a memory access controller 103. The convolution arithmetic circuit 102 performs a convolution operation. The memory access controller 103 is used to access the first cache memory 200, the second cache memory 300, the third cache memory 400, and the memory 500, and details thereof will be described later. In addition, the processor including the convolution arithmetic circuit 102 may be a neural network accelerator. The neural network accelerator is suitable for efficiently processing the above-described function of the artificial intelligence.

The plurality of first cache memories 200 includes a first cache memory 200a, a first cache memory 200b, a first cache memory 200c, and the like. The first cache memory 200a corresponds to the processor 101a, the first cache memory 200b corresponds to the processor 101b, and the first cache memory 200c corresponds to the processor 101c. For example, the first cache memory 200a transmits corresponding data to the processor 101a in response to a request from the processor 101a. Note that the first cache memories 200a to 200c and the like will be described as a “first cache memory 200” when described without being particularly distinguished. In the example of FIG. 1, three first cache memories 200 are illustrated, but the number of first cache memories 200 may be four or more, or may be less than three. For example, the first cache memory 200 includes a static random access memory (SRAM), but the first cache memory 200 is not limited to include the SRAM and may include a memory other than the SRAM.

The plurality of second cache memories 300 includes a second cache memory 300a, a second cache memory 300b, a second cache memory 300c, and the like. The second cache memory 300a corresponds to the processor 101a, the second cache memory 300b corresponds to the processor 101b, and the second cache memory 300c corresponds to the processor 101c. For example, when the data requested from the processor 101a is not in the first cache memory 200a, the second cache memory 300a transmits the corresponding data to the first cache memory 200a. Note that the second cache memories 300a to 300c and the like will be referred to as a “second cache memory 300” when described without being particularly distinguished. In the example of FIG. 1, three second cache memories 300 are illustrated, but the number of second cache memories 300 may be four or more or less than three. For example, the second cache memory 300 includes an SRAM, but the second cache memory 300 is not limited to include the SRAM and may include a memory other than the SRAM.

The third cache memory 400 is a cache memory farthest from the processor 101, that is, a last level cache (LLC). The third cache memory 400 is commonly used for the processors 101a to 101c and the like. For example, when the data requested from the processor 101a is not present in the first cache memory 200a or the second cache memory 300a, the third cache memory 400 transmits the corresponding data to the second cache memory 300a. For example, the third cache memory 400 includes an SRAM, but the third cache memory 400 is not limited to include the SRAM and may include a memory other than the SRAM.

The memory 500 is a storage device provided outside the arithmetic device 100. For example, the memory 500 is connected to the arithmetic device 100 via a bus or the like, and transmits and receives information to and from the arithmetic device 100. In the example of FIG. 1, the memory 500 includes a dynamic random access memory (DRAM) or a flash memory. Note that the memory 500 is not limited to include the DRAM and the flash memory, but may include a memory other than the DRAM and the flash memory. For example, when the data requested from the processor 101a is not in the first cache memory 200a, the second cache memory 300a, or the third cache memory 400, the memory 500 transmits the corresponding data to the third cache memory 400.

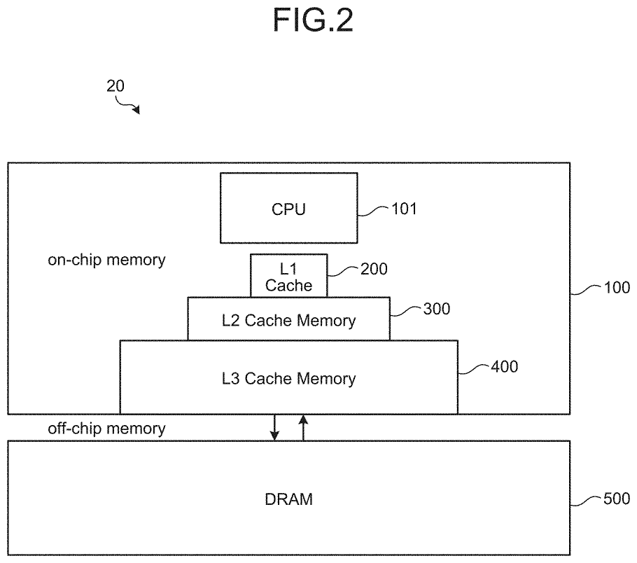

Here, the hierarchical structure of the memory of the processing system 10 illustrated in FIG. 1 will be described with reference to FIG. 2. FIG. 2 is a diagram illustrating an example of a hierarchical structure of a memory. Specifically, FIG. 2 is a diagram illustrating an example of a hierarchical structure of an off-chip memory and an on-chip memory. FIG. 2 illustrates an example in which the processor 101 is a CPU and the memory 500 is a DRAM.

As illustrated in FIG. 2, the first cache memory 200, the second cache memory 300, and the third cache memory 400 are on-chip memories. The memory 500 is an off-chip memory.

As illustrated in FIG. 2, a cache memory is often used as a memory close to an arithmetic unit such as the processor 101. The cache memory has a hierarchical structure as illustrated in FIG. 2. In the example of FIG. 2, the first cache memory 200 is a first hierarchical cache memory (L1 Cache) closest to the processor 101. The second cache memory 300 is a second hierarchical cache memory (L2 Cache) second closest to the processor 101 after the first cache memory 200. The third cache memory 400 is a third hierarchical cache memory (L3 Cache) third closest to the processor 101 after the second cache memory 300.

For example, the higher the cache memory, the higher the speed but the smaller the capacity of the memory. Therefore, access to data of a large size is realized by handling unnecessary data and necessary data. Hereinafter, an overall outline and the like will be described.

[1-2. Overall Outline and Problem]

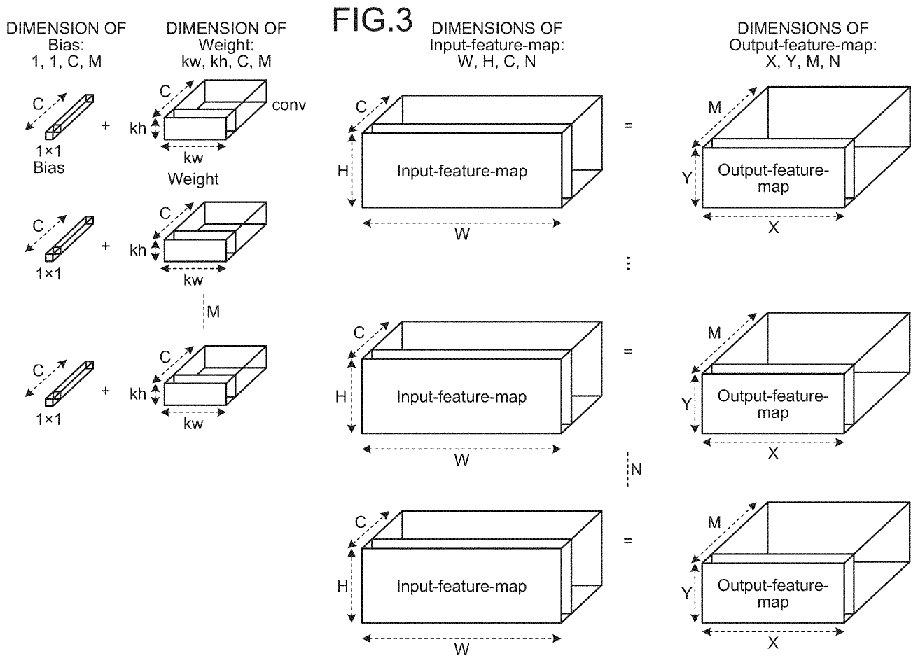

Next, an overall outline and a problem will be described with reference to FIGS. 3 to 8. First, a convolution operation (convolutional operation) will be described with reference to FIG. 3. FIG. 3 is a diagram illustrating an example of dimensions used for the convolution operation. As illustrated in FIG. 3, for example, data handled by a convolutional neural network (CNN) has up to four dimensions. Table 1 shows description of dimensions and examples of applications. Table 1 is conceptually illustrated in FIG. 3. Table 1 shows four dimensions used for the convolution operation. Although Table 1 shows five parameters, the maximum dimension is up to four when attention is paid to individual data (for example, input-feature-map or the like).

TABLE 1

| | Correspond to what in | |
|---|---|---|
| Symbol | CNN term | Application example |
| W | Input-feature-map | One-dimensional data such as a |
| | width | microphone or a |
| | | behavior/environment/acceleration |
| | | sensor |
| H | Input-feature-map | Second dimension data of image |
| | height | sensor |
| C | The number of | In a case where R, G, and B |
| | channels of Input- | directions of an image are to be |
| | feature-map = | convolved, or in a case where |
| | The number of | one-dimensional data of a |
| | channels of Weight = | plurality of sensors is subjected |
| | The number of | to convolution processing, a |
| | channels of Bias | dimension of a sum of |
| | | convolutions is increased by one |
| | | and defined as a channel |
| M | The number of | This dimension is used to adapt |
| | channels of Output- | the above channel concept between |
| | feature-map = | layers of the CNN. This |
| | The number of | corresponds to C of the next |
| | batches of Weight = | layer |
| | The Number of | |
| | batches of Bias | |
| N | The number of batches | When a plurality of sets of input |
| | of Input-feature-map = | data is processed in parallel by |
| | The number of | using the same coefficient, this |
| | batches of Output- | set direction is defined as |
| | feature-map | another dimension |

As shown in Table 1, the parameter “W” corresponds to the width of the Input-feature-map. For example, the parameter “W” corresponds to one-dimensional data such as a microphone or a behavior/environment/acceleration sensor (for example, the acceleration sensor 600c or the like). Hereinafter, the parameter “W” is also referred to as a “first parameter”.

The feature map after the convolution operation using the Input-feature-map is illustrated as the Output-feature-map. The parameter “X” corresponds to the width of the feature map (Output-feature-map) after the convolution operation. The parameter “X” corresponds to the parameter “W” of the next layer. When the parameter “X” is distinguished from the parameter “W”, the parameter “X” may be referred to as a “first parameter after operation”. Further, the parameter “W” may be referred to as a “first parameter before operation”.

The parameter “H” corresponds to the height of the Input-feature-map. For example, the parameter “H” corresponds to the second dimension data of the image sensor (for example, the image sensor 600a or the like). Hereinafter, the parameter “H” is also referred to as a “second parameter”.

The parameter “Y” corresponds to the height of the feature map (Output-feature-map) after the convolution operation. The parameter “Y” corresponds to the parameter “H” of the next layer. When the parameter “Y” is distinguished from the parameter “H”, the parameter “Y” may be referred to as a “second parameter after operation”. In addition, the parameter “H” may be set as a “second parameter before operation”.

Further, the parameter “C” corresponds to the number of channels of Input-feature-map, the number of channels of Weight, and the number of channels of Bias. For example, in a case where R, G, and B directions of an image are to be convolved or in a case where one-dimensional data of a plurality of sensors is subjected to convolution processing, the parameter “C” is defined as a channel by increasing a dimension of a sum of convolutions by one. Hereinafter, the parameter “C” is also referred to as a “third parameter”.

Further, the parameter “M” corresponds to the number of channels of the Output-feature-map, the number of batches of Weight, and the number of batches of Bias. For example, this dimension is used for the parameter “M” to adapt the above channel concept between layers of the CNN. The parameter “M” corresponds to the parameter “C” of the next layer. Hereinafter, the parameter “M” is also referred to as a “fourth parameter”.

The parameter “N” corresponds to the number of batches of Input-feature-map and the number of batches of Output-feature-map. For example, when a plurality of sets of input data is processed in parallel using the same coefficient, in the parameter “N”, this set direction is defined as another dimension. Hereinafter, the parameter “N” is also referred to as a “fifth parameter”.

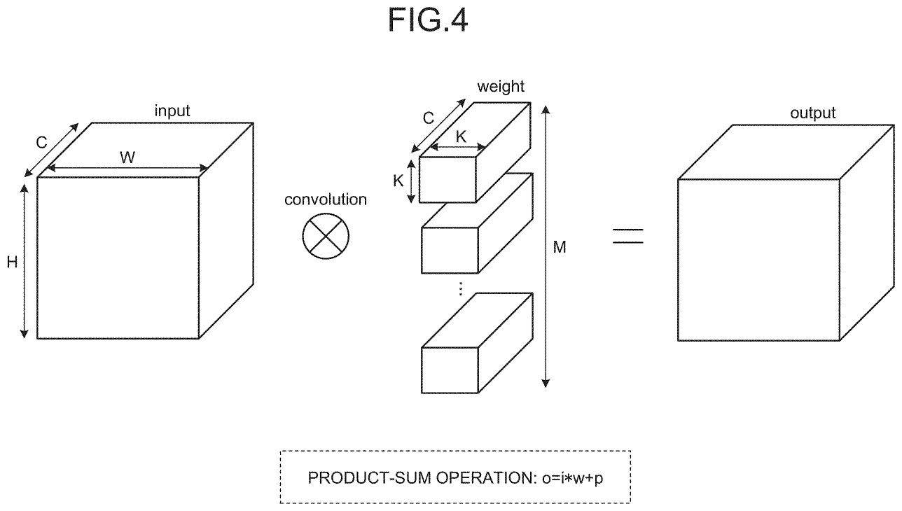

Here, convolution processing for performing a convolution operation will be described with reference to FIG. 4. FIG. 4 is a conceptual diagram illustrating a convolution process. For example, main elements constituting the neural network are a convolution layer and a fully connected layer, and a product-sum (operation) of elements of a high-dimensional tensor such as a four-dimensional tensor is performed in these layers. For example, as illustrated in “product-sum operation: o=i #w+p” in FIG. 4, the product-sum operation includes operations of a product of the input data i and the weight w, and a sum of a result of the product and an intermediate result p of the operation in order to calculate the output data o.

The sum of products of one time causes memory access of a total of four times including three data load (read) and one data store (write). For example, in the example of the convolution process illustrated in FIG. 4, the product-sum operation is performed 4HWK²CM times. Therefore, memory access is generated 4HWK²CM times. For example, even in a relatively small network for mobile terminals, since H and W are 10 to 200, K is 1 to 7, C is 3 to 1000, M is 32 to 1000, and the like, the number times of memory access reaches tens of thousands to several 100 billion times.

In general, the memory access consumes more power than the calculation itself, and for example, power of memory access to an off-chip such as a DRAM is several hundred times power for the calculation. Therefore, the power consumption can be reduced by reducing the memory access to the off-chip and accessing the memory close to the arithmetic unit. Therefore, reducing memory access to the off-chip is significantly important.

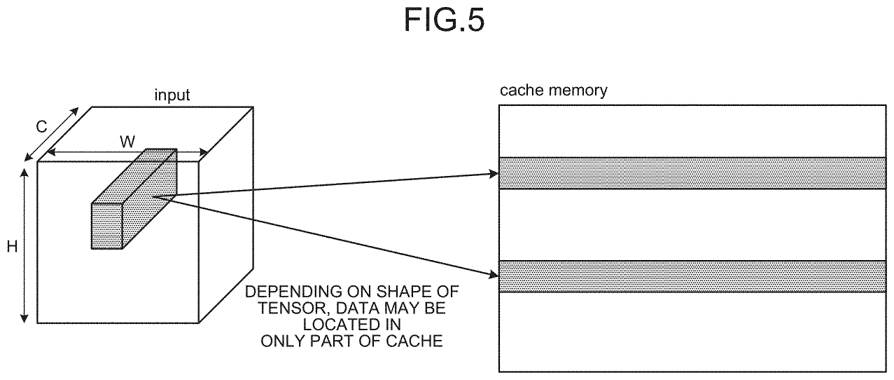

In the sum of products of the elements of the tensor described above, access to the same data frequently occurs, and thus data reusability is high. Specifically, when the convolution operation is performed, the tendency is remarkable. In a case where a cache memory configured by a general set-associative method is used, utilization efficiency of the memory may be impaired depending on a shape of a tensor used for an operation. For example, in a case where only part of the memory is used in the middle of the operation as illustrated in FIG. 5, there is a possibility that the utilization efficiency of the memory is significantly impaired. FIG. 5 is a diagram illustrating an example of storing tensor data in a cache memory. In addition, since it is only possible at the time of execution to know at which position on the memory data is disposed, it is difficult to perform optimization by a program.

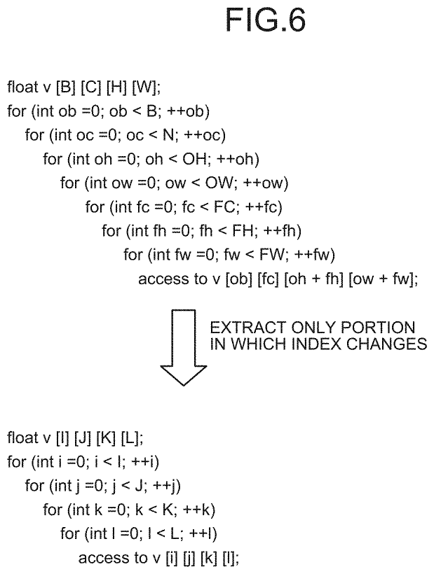

Therefore, as a technique of reducing access to the off-chip memory without using the cache memory, a method of including an internal buffer is also conceivable. Since the data loaded from the DRAM is directly carried to the internal buffer, the frequency of access to the DRAM can be reduced by optimizing the use of the internal buffer. However, the interface between the internal buffer and the DRAM is required to be exchanged with each other by using an address of data. An example thereof is illustrated in FIG. 6. FIG. 6 is a diagram illustrating an example of a convolution operation program and abstraction thereof.

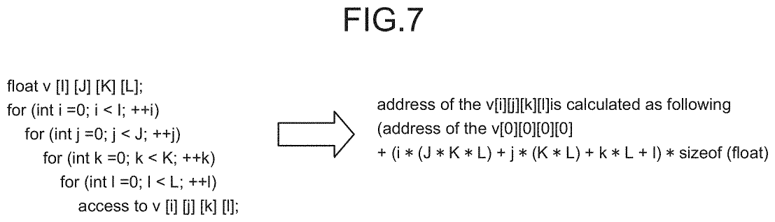

In addition, address calculation in a case where four-dimensional tensor data is accessed is illustrated in FIG. 7. FIG. 7 is a diagram illustrating an example of address calculation when an element of a tensor is accessed. As described above, it is necessary to perform the product six times and the sum three times only with the portion using the index information until the conversion from the index information such as i, j, k, and 1 into the address. Therefore, in the case of accessing four-dimensional data, many commands are required to access one element.

As described above, when dedicated hardware for performing only a command corresponding to an address calculation and the address calculation is prepared, and the address calculation is offloaded to the hardware, the performance can be improved and the power consumption can be suppressed. However, the product and the sum for the address calculation are necessarily performed every access. Therefore, for example, a configuration of a memory that optimizes the cache memory and uses it efficiently, and suppresses an increase in address calculation itself when performing a task that requires a high-dimensional tensor product will be described in the following first embodiment.

### 1-3. First Embodiment

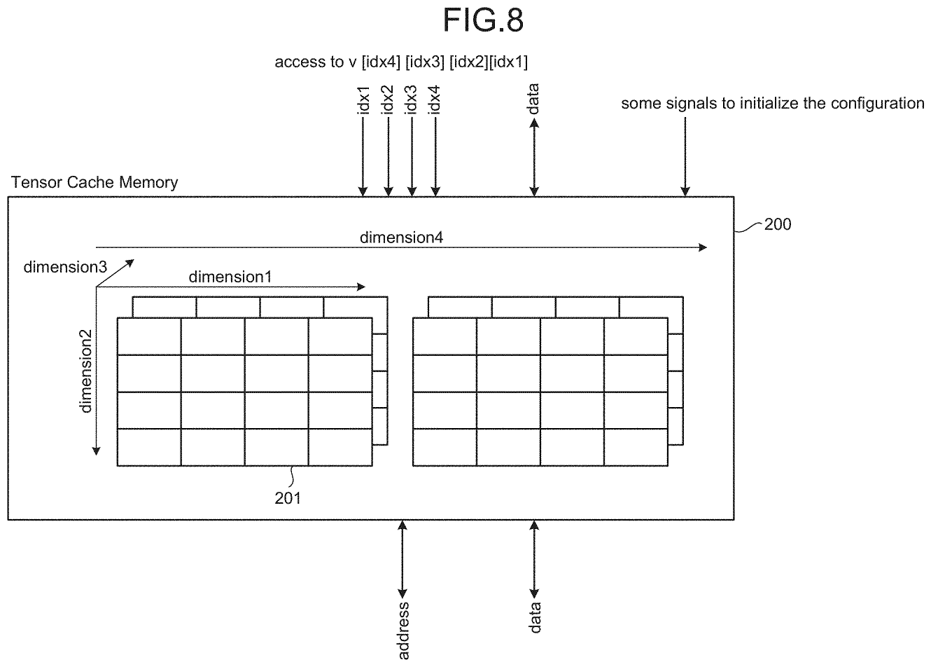

Next, a first embodiment will be described with reference to FIGS. 8 to 16. First, an outline of the first embodiment will be described with reference to FIG. 8. FIG. 8 is a conceptual diagram according to the first embodiment. In FIG. 8, the first cache memory 200 will be described as an example, but the memory is not limited to the first cache memory 200, and may be applied to various memories such as the second cache memory 300, the third cache memory 400, and the memory 500. Note that, in the following example, access to four-dimensional data is illustrated as an example, but access to lower-dimensional data and access to higher-dimensional data depending on a hardware resource are permitted.

The first cache memory 200 illustrated in FIG. 8 is a type of cache memory, and accesses data by using index information of a tensor to be accessed instead of accessing data by an address as in a conventional cache memory. A case where the first cache memory 200 illustrated in FIG. 8 has a plurality of partial cache memory areas 201, and access is performed using idx1, idx2, idx3, idx4, and the like which are index information will be described as an example.

FIG. 8 illustrates an example in which a lower-level memory (for example, the memory 500) is accessed using an address in a case where the data is not present in the cache memory (the first cache memory 200) in the access using the index information. Note that, in the case of hierarchization using a plurality of cache memories as illustrated in FIG. 1, the index information is transferred to a further lower memory, and the data is searched for.

In this case, when the data is not present in the first cache memory 200 in the access using the index information, the index information is transferred to the cache memory (the second cache memory 300) immediately below the first cache memory 200, and the data is searched for in the second cache memory 300. When the data is not present in the second cache memory 300 in the access using the index information, the index information is transferred to the cache memory (third cache memory 400) immediately below the second cache memory 300, and the data is searched for in the third cache memory 400. In addition, in a case where the data is not present in the third cache memory 400 in the access using the index information, the memory 500 is accessed using the address.

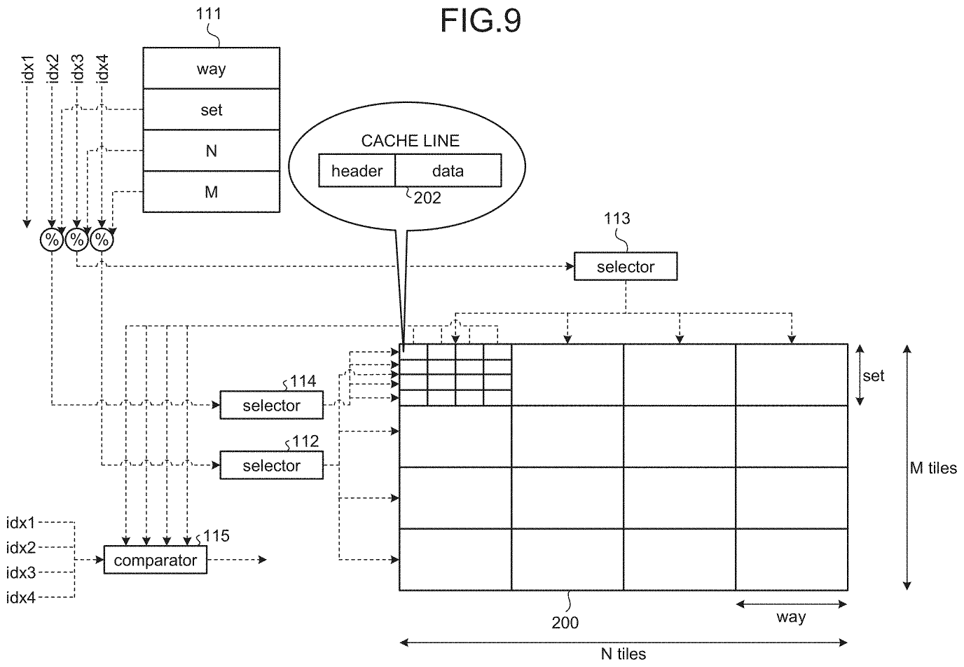

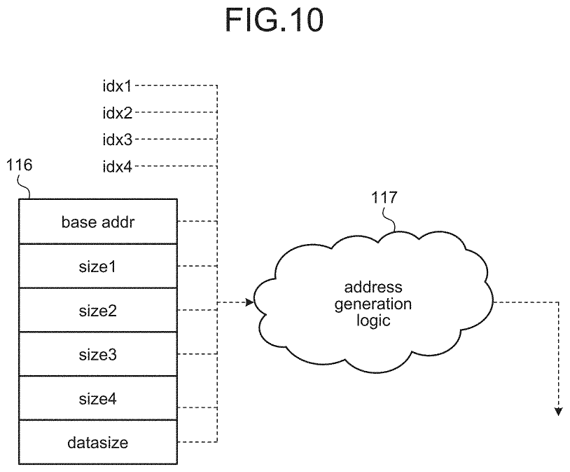

A specific example will be described below with reference to FIGS. 9 and 10. FIGS. 9 and 10 are diagrams illustrating an example of a process according to the first embodiment. In the present embodiment, the first cache memory 200 is a representative example of the cache memory according to the present invention, and is referred to as a cache memory 200. Further, in the embodiment, a partial cache memory area 201 is referred to as a tile.

First, in FIG. 9, a register 111 is a register that holds configuration information of a cache memory. For example, the memory built-in device 20 includes a register 111. The register 111 holds information indicating that one tile includes the set*way cache lines 202 and the entire cache includes M*N tiles. In the embodiment, the value way, the value set, the value N, and the value M correspond to dimension1, dimension2, dimension3, and dimension4 in FIG. 8, respectively. For example, these values may be fixed at the time of configuring the cache memory. For example, the value M of the register 111 is used for the memory built-in device 20 to select only one tile from the tiles (M tiles) in one direction (for example, the height direction) by a remainder obtained by dividing the index information idx4 by the value M in the example of FIG. 9. Similarly, the value set and the value N are also used for selection of a set and selection of a tile, respectively. Since way is not used at the time of memory access, way may not be held in the register 111. Note that the “set” is a plurality of (two or more) cache lines continuously disposed in the width direction in one tile, and the “way” is a plurality of (two or more) cache lines continuously disposed in the height direction in one tile.

The cache line 202 illustrated in FIG. 9 represents a minimum unit of data. For example, as in a normal cache memory, the cache line 202 includes a header information portion for determining whether data is desired and a data information portion for storing actual data. The header information of the cache line 202 includes information corresponding to a tag such as index information for identifying data, information for selecting a replacement target, and the like. Note that information used for the header and how to allocate the information are allowed to have any configuration.

In FIG. 9, the cache memory 200 represents the entire cache memory, includes a plurality of partial cache memory areas 201, and as described above, the partial cache memory area 201 is referred to as a tile. In addition, a tile includes a plurality of (two or more) cache lines 202, and the cache memory 200 includes a plurality of (two or more) tiles. That is, in the cache memory 200 of FIG. 9, each of rectangular regions each indicated by the height set and the width way corresponds to a partial cache memory area 201 called a tile. That is, in the example of FIG. 9, a total of 16 tiles with 4 tiles in the height direction×4 tiles in the width direction are illustrated.

In FIG. 9, a selector 112 is used to select which tile is to be used among the M tiles (for example, the tiles in the height direction) disposed in a first direction in the cache memory 200. For example, the selector 112 selects which tile to use among the M tiles using a remainder (remainder) obtained by dividing the index information idx4 illustrated in FIG. 8 by the value “M”. For example, the memory built-in device 20 includes the selector 112.

In FIG. 9, a selector 113 selects which tile to use from N tiles (for example, tiles in the width direction) disposed in a second direction different from the first direction of the cache memory 200. For example, the selector 113 selects which tile to use among the N tiles using a remainder (remainder) obtained by dividing the index information idx3 illustrated in FIG. 8 by the value N. For example, the memory built-in device 20 includes the selector 113. One of the plurality of tiles of the cache memory 200 is selected by the selector 112 and the selector 113.

In FIG. 9, a selector 114 selects which “set” to use in the tile selected by the combination of the selector 112 and the selector 113. For example, the selector 114 selects which “set” in the tile to use by using a remainder (remainder) obtained by dividing the index information idx2 illustrated in FIG. 8 by the value set. For example, the memory built-in device 20 includes the selector 114.

In FIG. 9, a comparator 115 is used to compare the header information of all the way cache lines 202 in a “set” selected by the selector 112, the selector 113, and the selector 114 with the index information idx1 to idx4 and the like. That is, it is a circuit that determines a so-called cache hit (whether data exists in the cache memory 200). The comparator 115 compares the header information of all the way cache lines 202 in a “set” with the index information idx1 to idx4 and the like. Then, as a result of comparison, the comparator 115 outputs information of “hit (corresponding data present)” if there is a match, and outputs information of “miss (corresponding data not present)” if not. That is, the comparator 115 determines whether there is desired data in the line in the “set”, and generates a hit or miss signal. For example, the memory built-in device 20 includes the comparator 115.

In FIG. 10, a register 116 is a register that holds a head address (base addr) of a tensor to be accessed, a size (size1) of a dimension 1, a size (size2) of a dimension 2, a size (size3) of a dimension 3, a size (size4) of a dimension 4, and a data size (datasize) of the tensor. For example, the memory built-in device 20 includes the register 116.

When the information (value miss) indicating the cache miss is output from the comparator 115 in FIG. 9, an address generation logic 117 generates the address using the information of the register 116 and the index information idx1 to idx4. For example, the memory built-in device 20 includes the address generation logic 117. The memory access controller 103 may have the function of the address generation logic 117. An address calculation formula is expressed by the following Expression (1).

address=(base addr)+(idx4*(size1*size2*size3)+idx3*(size1*size2)+idx2*size1+idx1) *datasize (1)

where datasize in Expression (1) is the data size (for example, the number of bytes) indicated in the register 116, and is a numerical value such as “4” in the case of float (for example, a 4-byte single-precision floating-point real number), or a numerical value such as 2 in the case of short (for example, a 2-byte signed integer). For the calculation of the address by the address generation logic 117, any configuration is allowed as long as the address can be generated from the index information.

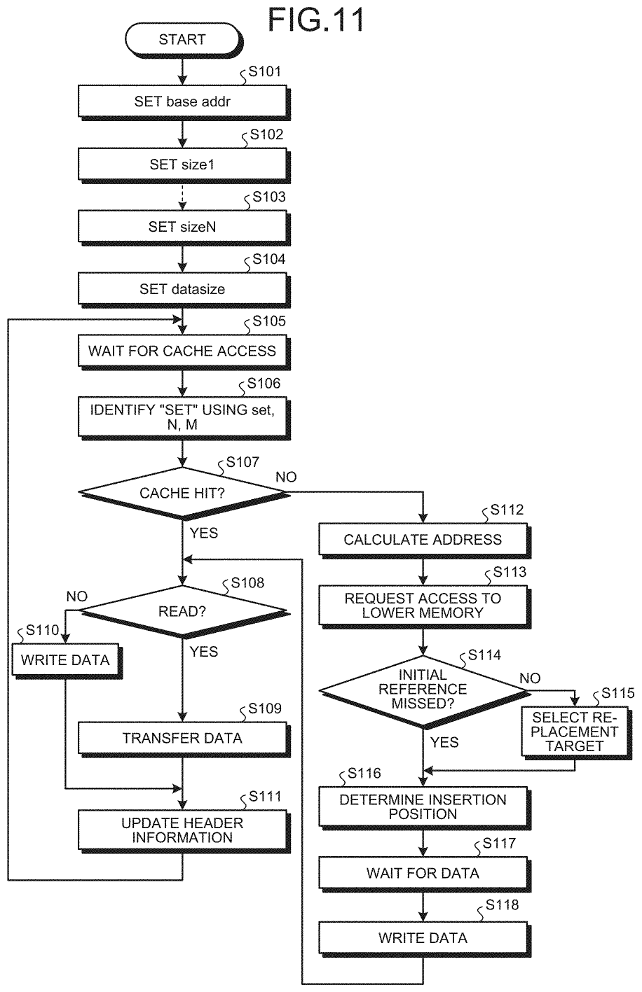

Next, a procedure of processing according to the first embodiment will be described with reference to FIG. 11. FIG. 11 is a flowchart illustrating a procedure of processing according to the first embodiment. Note that, in the example of FIG. 11, the arithmetic device 100 will be described as a processing subject, but the processing subject may be replaced with the first cache memory 200, the memory built-in device 20, or the like according to the content of the processing.

As illustrated in FIG. 11, the arithmetic device 100 sets base addr (Step S101). The arithmetic device 100 sets base addr illustrated in the register 116 of FIG. 10.

The arithmetic device 100 sets size1 (Step S102). The arithmetic device 100 sets size1 illustrated in the register 116 of FIG. 10.

The arithmetic device 100 sets sizeN (Step S103). The arithmetic device 100 sets sizeN illustrated in the register 116 of FIG. 10. Note that “N” of sizeN is any value, and only Steps S102 and S103 are illustrated in FIG. 11, but the size is set by the number of sizes (the number of dimensions). For example, in the example of FIG. 10, “N” of sizeN is “4”, and the arithmetic device 100 sets each of size1, size2, size3, and size4.

The arithmetic device 100 sets datasize (Step S104). The arithmetic device 100 sets datasize illustrated in the register 116 of FIG. 10.

The arithmetic device 100 waits for a cache access (Step S105). Then, the arithmetic device 100 identifies a “set” using set, N, and M (Step S106).

In a case where the cache is hit (Step S107: Yes), if the processing is read (Step S108: Yes), the arithmetic device 100 transfers data (Step S109). For example, in a case where the cache is hit (in a case where the data is in the first cache memory 200), if the process is read, the first cache memory 200 transfers the data to the processor 101.

In addition, in a case where the cache is hit (Step S107: Yes), if the process is not read (Step S108: No), the arithmetic device 100 writes data (Step S110). For example, in a case where the cache is hit (in a case where the data is in the first cache memory 200), when the process is not read but write, the first cache memory 200 writes data.

Then, the arithmetic device 100 updates the header information (Step S111), and returns to Step S105 and repeats the process.

In a case where the cache is not hit (Step S107: No), the arithmetic device 100 calculates an address (Step S112). Then, the arithmetic device 100 requests an access to the lower memory (Step S113). For example, in a case where the cache is not hit (in a case where the data is not in the first cache memory 200), the arithmetic device 100 generates an address and requests an access to the memory 500.

When the initial reference is not missed (Step S114: No), the arithmetic device 100 selects a replacement target (Step S115) and determines an insertion position (Step S116). When the initial reference is missed (Step S114: Yes), the arithmetic device 100 determines the insertion position (Step S116).

Then, after waiting for the data (Step S117), the arithmetic device 100 writes the data (Step S118). Then, the processing from Step S108 is performed.

With the configuration and the process of FIGS. 9 to 11 described above, the software developer sees the memory of FIG. 8, and thus the memory built-in device 20 can facilitate optimization in a task that requires access to tensor data. Furthermore, as the cache hit rate increases due to the optimization, the memory built-in device 20 can reduce the number of times of processing corresponding to address calculation.

Note that, in a case where a modification is added to the processing, after “setting datasize” in Step S104, the desired information is written into the register and the process of “identifying a “set” using set, N, M” in Step S106 is changed to a process using the additional information.

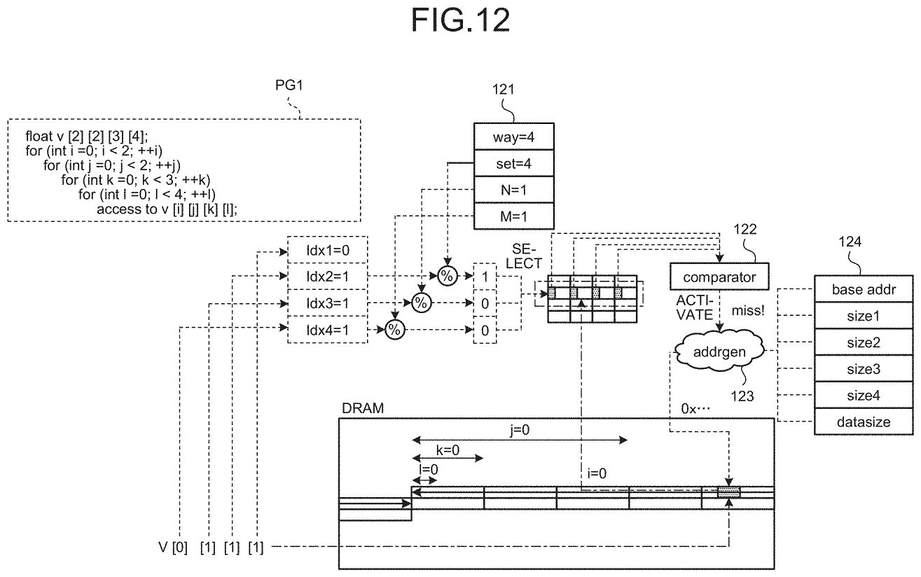

Here, an example of a specific tensor access will be described with reference to FIG. 12. FIG. 12 is a diagram illustrating an example of a memory access according to the first embodiment. Note that, in FIG. 12, the index information idx1 to idx4 connected to a comparator 122 and an address generation logic 123 (addrgen) is omitted, and description will be made from a state after completion of initialization of each register.

An example of the access in FIG. 12 is an access to the 4-dimensional tensor v of the program PG1 in the upper left of FIG. 12, and in FIG. 12, it is assumed that it is timing at which the access to v [0] [1] [1] [1] is missed.

First, as illustrated in FIG. 12, index information 0, 1, 1, and 1 of V [0] [1] [1] [1] are set to idx1 to idx4, respectively, and the memory is accessed using the index information idx1 to idx4. In this case, the access using the index information is performed by the following unique command or a dedicated accelerator.

(command)

ld idx4, idx3, idx2, idx1

st idx4, idx3, idx2, idx1

Next, as illustrated in FIG. 12, the corresponding “set” is selected by using a remainder (remainder) obtained by dividing values of the index information idx2 to idx4 by the value set, the value N, and the value M, respectively. In the example of FIG. 12, the selector selects the corresponding “set” using the index information of idx2=1, idx3=1, and idx4=1 and the information of a register 121 of set=4, N=1, and M=1. For example, the memory built-in device 20 includes the register 121.

Next, as illustrated in FIG. 12, the header information of all the cache lines in the “set” and the index information idx1 to idx4 are input to the comparator 122, and a cache miss (miss) is determined. The comparator 122 is a circuit having a function similar to that of the comparator 115 in FIG. 9.

Next, as illustrated in FIG. 12, the address generation logic 123 calculates an address using the index information idx1 to idx4 and the information about base addr, each size (size1 to size4), and datasize. The address generation logic 123 is similar to the address generation logic 117 in FIG. 10.

Next, as illustrated in FIG. 12, the memory built-in device 20 accesses the DRAM (for example, the memory 500) at the calculated address. Note that the symbols i, j, k, and 1 in the DRAM correspond to symbols used in the program PG1 in FIG. 12 and are described for explanation in correspondence with the program PG1, and are actually calculated using the index information idx1 to idx4, and information about base addr, each size (size1 to size4), and datasize in order to access the DRAM.

Finally, as illustrated in FIG. 12, data is inserted from the DRAM into the cache memory (the first cache memory 200 or the like).

[1-3-1. Modification]

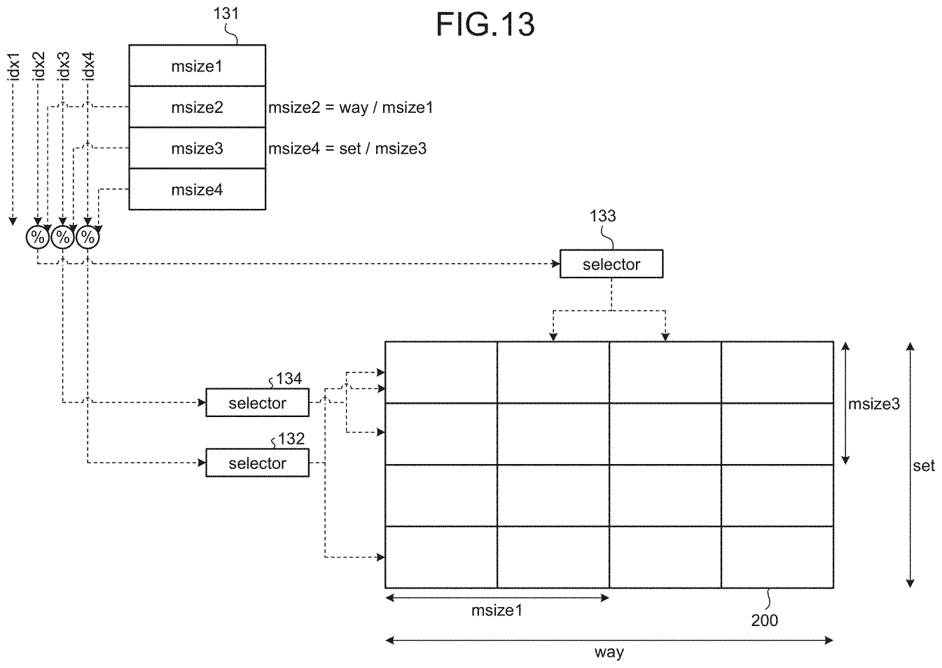

Here, a modification according to the first embodiment will be described with reference to FIG. 13. FIG. 13 is a diagram illustrating a modification according to the first embodiment. FIG. 13 illustrates an example of a case where the tile is not used and the cache memory is configured only with set and way. Note that, in FIG. 13, only differences from FIGS. 9 and 10 are illustrated, and the description of the same points is appropriately omitted.

In FIG. 13, a register 131 is a register that holds allocation information of a cache memory to be used. For example, the memory built-in device 20 includes the register 131. The value msize1 indicates how many cache lines in the way direction are grouped, and the value msize2 indicates how many groups (also referred to as lumps) of msize1 cache lines are present in the way direction. In addition, the value msize3 represents how many “sets” in the set direction are grouped, and the value msize4 represents how many groups of msize3 cache lines are present in the set direction. In this case, msize2=way/msize1, and msize4=set/msize3. Furthermore, since msize1 is information that is not used during memory access, only msize2 is held, and msize1 does not need to be held in the register 131.

In FIG. 13, as in a normal cache memory, the cache memory 200 is a memory including a set of set*way cache lines.

In FIG. 13, a selector 132 selects a group of the msize3 cache lines by using a value of a remainder (remainder) obtained by dividing the index information corresponding to the index information idx4 of FIG. 8 by the value msize4. That is, the selector 132 selects which group is to be used in one direction (for example, the height direction). For example, the memory built-in device 20 includes the selector 132.

In FIG. 13, a selector 133 selects a group of the msize1 cache lines by using a value of a remainder (remainder) obtained by dividing the index information corresponding to the index information idx2 of FIG. 8 by the value msize2. That is, the selector 133 selects which group is to be used in another direction (for example, the width direction). For example, the memory built-in device 20 includes the selector 133.

In FIG. 13, which “set” is used is selected from the group selected by the selector 132 by a value of a remainder (remainder) obtained by dividing the index information corresponding to the index information idx3 of FIG. 8 by the value msize3. That is, a selector 134 selects which “set” of the group is used by using a remainder (remainder) obtained by dividing the index information idx3 by the value msize3. For example, the memory built-in device 20 includes the selector 134.

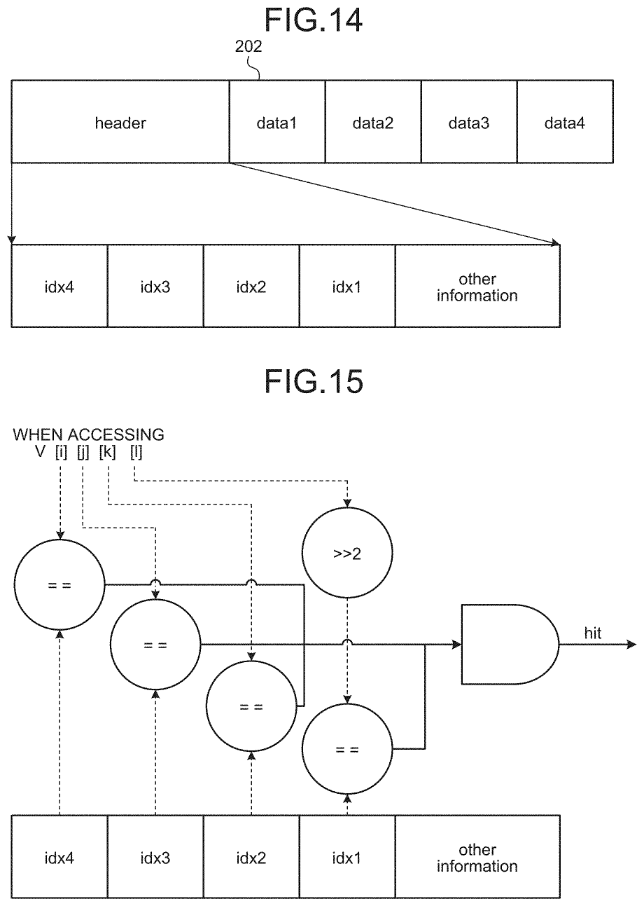

Here, the cache line will be described with reference to FIG. 14. FIG. 14 is a diagram illustrating an example of a configuration of a cache line. FIG. 14 illustrates an example of a configuration in a case where data of a plurality of words (word) is included in the cache line 202. In the example of FIG. 14, a case where data of 4 words is stored in one line is illustrated, and in a case where used for cache hit determination of hit or miss, idx1 which is index information having the lowest dimension is stored while discarding lower 2 bits.

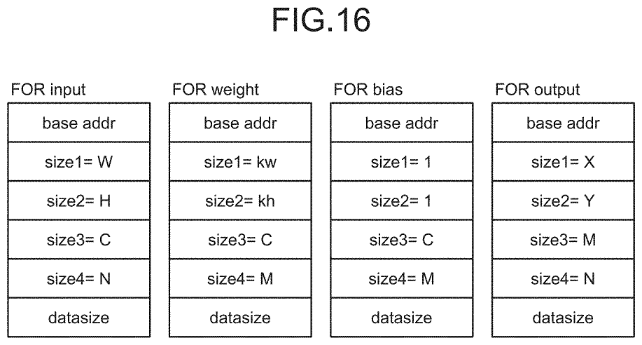

The cache hit determination in a case where the cache line 202 as illustrated in FIG. 14 is configured is performed by a hardware configuration as illustrated in FIG. 15. FIG. 15 is a diagram illustrating an example of hit determination regarding a cache line. Specifically, FIG. 15 is a diagram illustrating an example of cache hit determination in a case where there is a plurality of words in the cache line. For example, among v [i] [j] [k] [l], i is compared with idx4, j is compared with idx3, k is compared with idx2, and l is shifted two bits to the right (discarding the lower 2 bits) and then compared with idx1.

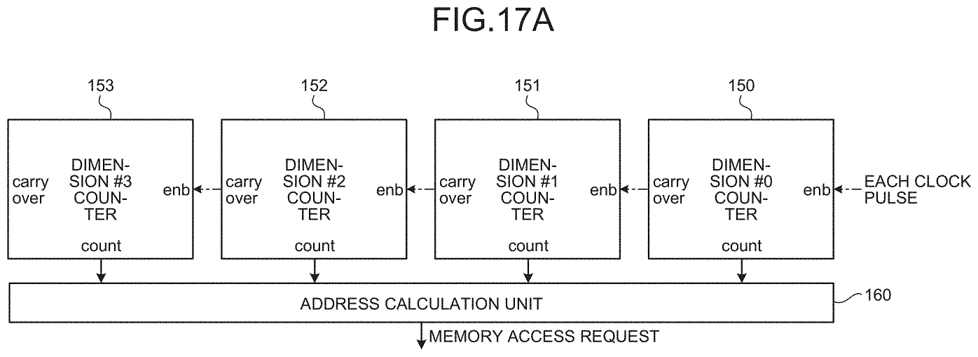

Next, initial setting in a case where the CNN processing is performed will be described with reference to FIG. 16. FIG. 16 is a diagram illustrating an example of initial setting in a case where the CNN processing is performed. FIG. 16 illustrates four initial settings for input, for weight, for bias, and for output.

For example, one cache memory is used for each tensor, and information of each dimension or the like is written to the setting register for each cache memory. For example, in the case of input-feature-map, in FIG. 16, the size in the one-dimensional direction is W, the size in the two-dimensional direction is H, the size in the three-dimensional direction is C, and the size in the four-dimensional direction is N. Therefore, the memory built-in device 20 writes W in size1, H in size2, C in size3, and N in size4. As described above, the memory built-in device 20 designates a first parameter related to the first dimension of the data, a second parameter related to the second dimension of the data, a third parameter related to the third dimension of the data, and a fifth parameter related to the number of pieces of data. In addition, appropriate values are designated in base addr and datasize.

As described above, in the first embodiment, the memory built-in device 20 is a type of cache memory, and constitutes, as a cache memory specialized in accessing the tensor, a memory such as the first cache memory 200. In this case, unlike a normal cache memory, the memory built-in device 20 can control access by using index information of a tensor to be accessed instead of an address. In addition, the configuration of the cache is adapted to the shape of the tensor. In addition, the memory built-in device 20 includes an address generator (address generation logic 117 or the like) in order to be compatible with a general memory that requires access by an address. As a result, the memory built-in device 20 can enable appropriate access to the memory. The memory built-in device 20 can change the correspondence relationship with the address of the cache memory according to designation of the parameter. The memory built-in device 20 can change the address space of the cache memory according to designation of the parameter. That is, the memory built-in device 20 can set a parameter to change the address space of the cache memory. The memory built-in device 20 can deform the address space of the cache memory according to the designation of the parameter.

In the first embodiment, since the memory built-in device 20 has the above configuration, the access of the tensor and the arrangement on the memory match, so that the software developer can easily generate the more optimal code and the memory can be fully used. In addition, since the memory built-in device 20 generates the address only when the data does not exist in the cache memory, the cost for the address generation can be reduced.

### 1-4. Second Embodiment

Next, a second embodiment will be described. Although a memory built-in device 20A will be described below as an example, the memory built-in device 20A may have the same configuration as the memory built-in device 20.

[1-4-1. Premise and Others]

First, prior to the description of the second embodiment, a premise and the like related to the second embodiment will be described.

The configuration of the convolution arithmetic circuit as described above is fixed. For example, a data path including a data buffer and an arithmetic unit (MAC: multiplier accumulator) is not changed once hardware (semiconductor chip or the like) is completed. On the other hand, in the software, the arrangement of data is determined according to the pre-processing and post-processing offloaded to the CNN arithmetic circuit. This is because it is possible to optimize the efficiency of software development and the scale of software. In addition, instead of software, hardware such as a sensor may directly store data of the CNN calculation in a memory. At this time, the sensor stores data on the memory in a fixed arrangement based on its own hardware specification. In this way, the arithmetic circuit is required to efficiently access software that does not consider the configuration of the arithmetic circuit or data stored by a sensor.

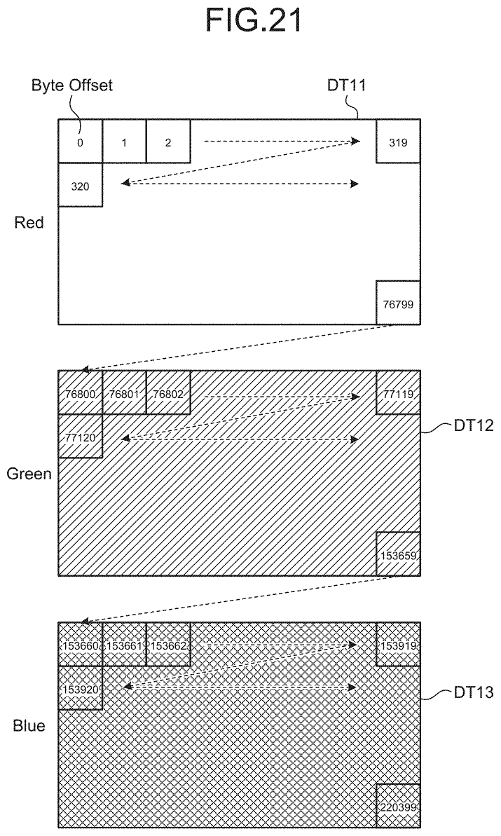

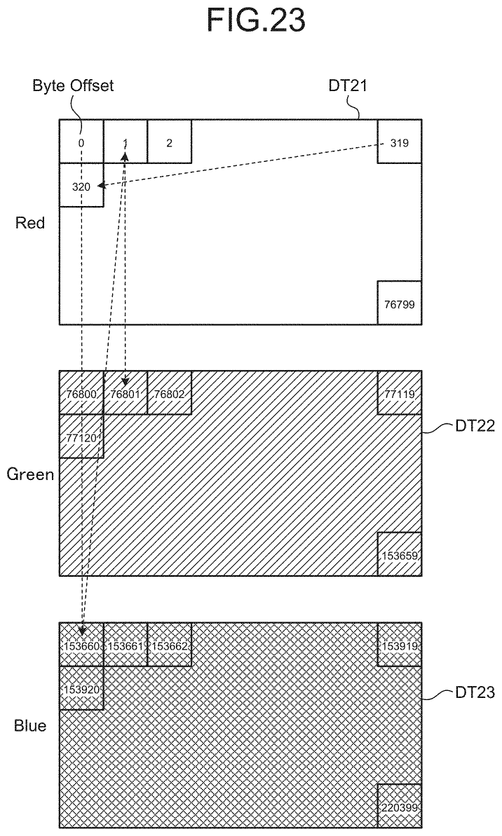

However, when the data access order of the arithmetic circuit is also fixed, there is a problem that access cannot be efficiently performed. For example, in a circuit configuration X in which a product-sum operation (MAC operation) can be performed on three 8-bit pixels at the same time (one cycle), when an RGB image convolution process is performed, convolution of the R channel first, then convolution of the G channel, and finally convolution of the B channel results in the smallest number of cycles. Therefore, a layout A (see, for example, FIGS. 21 and 23) in which successive pixels of each channel are read in order is optimal. On the other hand, in the case of the circuit configuration Y in which there are three circuits that perform the product-sum operation on pixels on a one-by-one basis in one cycle, it is preferable to arrange the layout B in which pixels are read on a one-by-one basis for each of R, G, and B. However, in a case where the combination of the circuit configuration X and the layout B is used due to the reason of the specification of the software or the sensor described above, when the data access order of the arithmetic circuit is fixed, an extra number of cycles is required to read data from the memory, or the arrangement of the arithmetic unit cannot be fully utilized and the number of cycles is increased as a whole.

As a method for solving this problem, there are a first method in which software rearranges the arrangement on a memory before a CNN task, a second method in which part of loop processing is offloaded to hardware, a third method in which an address is calculated by software, and the like. However, the first method has problems that the calculation cost is high and the memory use efficiency is poor because two kinds of copies of data are required. In addition, the second method has a problem that the calculation cost is high because loop processing is performed by a command of a processor. In addition, the third method has a problem that the address calculation cost increases. Therefore, a configuration capable of enabling appropriate access to the memory will be described in the following second embodiment.

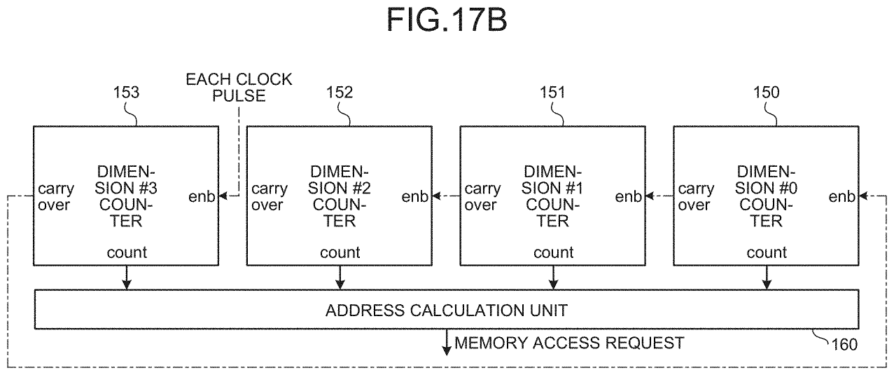

Hereinafter, the configuration and the process of the second embodiment will be specifically described with reference to FIGS. 17A to 23. First, an outline of the second embodiment will be described with reference to FIGS. 17A and 17B. FIGS. 17A and 17B are diagrams illustrating an example of address generation according to the second embodiment. Hereinafter, in a case where FIG. 17A and FIG. 17B are described without distinction, they may be referred to as FIG. 17.

FIG. 17 illustrates a case where an address is generated using a dimension #0 counter 150, a dimension #1 counter 151, a dimension #2 counter 152, a dimension #3 counter 153, and an address calculation unit 160. For example, the memory built-in device 20A performs a memory access request using the address generated by the address calculation unit 160 using the count value of each of the dimension #0 counter 150, the dimension #1 counter 151, the dimension #2 counter 152, and the dimension #3 counter 153. For example, the address calculation unit 160 may be an arithmetic circuit that receives the count (value) of each of the dimension #0 counter 150, the dimension #1 counter 151, the dimension #2 counter 152, and the dimension #3 counter 153 as an input, calculates an address corresponding to the input to output the calculated address. Hereinafter, the dimension #0 counter 150, the dimension #1 counter 151, the dimension #2 counter 152, the dimension #3 counter 153, and the address calculation unit 160 may be collectively referred to as an “address generator”.

FIG. 17A illustrates a case where a clock pulse is input to the dimension #0 counter 150, and the dimension #0 counter 150, the dimension #1 counter 151, the dimension #2 counter 152, and the dimension #3 counter 153 are connected in this order. Specifically, connection is made such that the carry-over pulse signal of the dimension #0 counter 150 is input to the dimension #1 counter 151, connection is made such that the carry-over pulse signal of the dimension #1 counter 151 is input to the dimension #2 counter 152, and connection is made such that the carry-over pulse signal of the dimension #2 counter 152 is input to the dimension #3 counter 153.

In addition, FIG. 17B illustrates a case where a clock pulse is input to the dimension #3 counter 153, and the dimension #3 counter 153, the dimension #0 counter 150, the dimension #1 counter 151, and the dimension #2 counter 152 are connected in this order. Specifically, connection is made such that the carry-over pulse signal of the dimension #3 counter 153 is input to the dimension #0 counter 150, connection is made such that the carry-over pulse signal of the dimension #0 counter 150 is input to the dimension #1 counter 151, and connection is made such that the carry-over pulse signal of the dimension #1 counter 151 is input to the dimension #2 counter 152.

As illustrated in FIG. 17, indexes of a plurality of dimensions are calculated by counters, and connections of carry-over pulse signals of the plurality of counters can be freely changed in a changeable manner. The memory built-in device 20A calculates an address from a plurality of indexes (counter values) and a multiplier of a preset dimension (dimensions separation width).

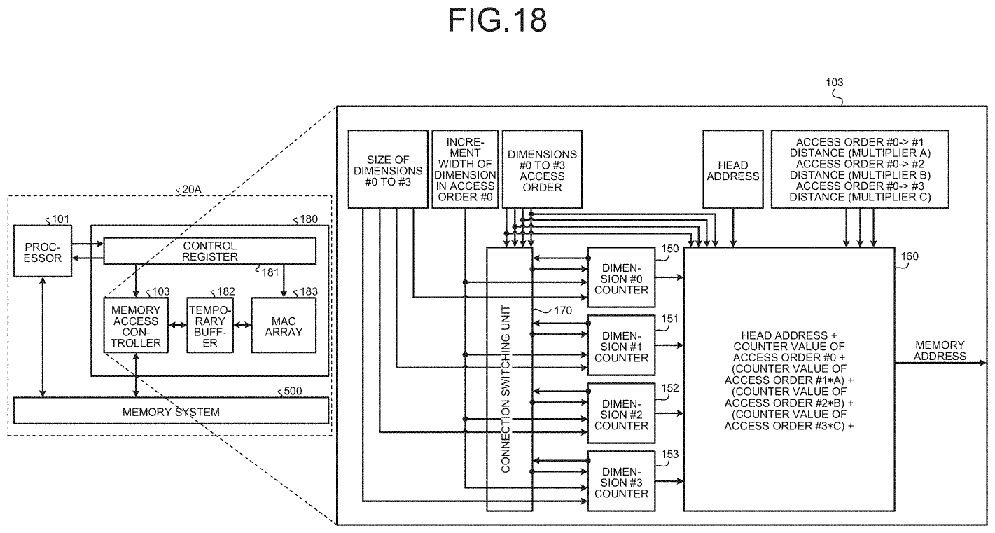

FIG. 18 illustrates an example of the memory access controller 103. FIG. 18 is a diagram illustrating an example of the memory access controller. The memory built-in device 20A illustrated in FIG. 18 includes a processor 101 and an arithmetic circuit 180. As described above, in FIG. 18, the memory access controller 103 is included in the arithmetic circuit 180. Although the memory access controller 103 is illustrated outside the processor 101 in the example of FIG. 18, the memory access controller 103 may be included in the processor 101. The arithmetic circuit 180 may be integrated with the processor 101.

The arithmetic circuit 180 illustrated in FIG. 18 includes a control register 181, a temporary buffer 182, an MAC array 183, and the like in addition to the memory access controller 103. The control register 181 is a register included in the arithmetic circuit 180. For example, the control register 181 is a register (control device) used for control of receiving a command read from a storage device (memory system) such as the memory 500 via the memory access controller 103 and temporarily storing the command for execution. The temporary buffer 182 is a buffer included in the arithmetic circuit 180. For example, the temporary buffer 182 is a storage device or a storage area that temporarily stores data. The MAC array 183 is an MAC (product-sum arithmetic unit) array included in the arithmetic circuit 180.

The memory access controller 103 includes a dimension #0 counter 150, a dimension #1 counter 151, a dimension #2 counter 152, a dimension #3 counter 153, an address calculation unit 160, a connection switching unit 170, and the like. Information indicating the sizes of the dimensions #0 to #3 and the increment width of the dimension of the access order #0 are input to the dimension #0 counter 150, the dimension #1 counter 151, the dimension #2 counter 152, and the dimension #3 counter 153. Information indicating the size of the dimension #0 is input to the dimension #0 counter 150. For example, a first parameter related to the first dimension of data is set in the dimension #0 counter 150. Information indicating the size of the dimension #1 is input to the dimension #1 counter 151. For example, a second parameter related to the second dimension of data is set in the dimension #1 counter 151. Information indicating the size of the dimension #2 is input to the dimension #2 counter 152. For example, a third parameter related to the third dimension of data is set in the dimension #2 counter 152. In the example of FIG. 18, the memory access controller 103 mounted on the arithmetic circuit 180 has the address generator. In the example of FIG. 18, the memory access controller 103 can perform memory access in any order by the software setting the connection order in advance in the connection switching unit 170 that switches the connection of the carry-over signals of the four counters. In addition, information indicating the access order of the dimensions #0 to #3, information indicating the head address, and the like are input to the address calculation unit 160. In addition, information indicating the access order of the dimensions #0 to #3 is input to the connection switching unit 170. The connection switching unit 170 switches the connection order of the dimension #0 counter 150, the dimension #1 counter 151, the dimension #2 counter 152, and the dimension #3 counter 153 based on the information indicating the access order of the dimensions #0 to #3.

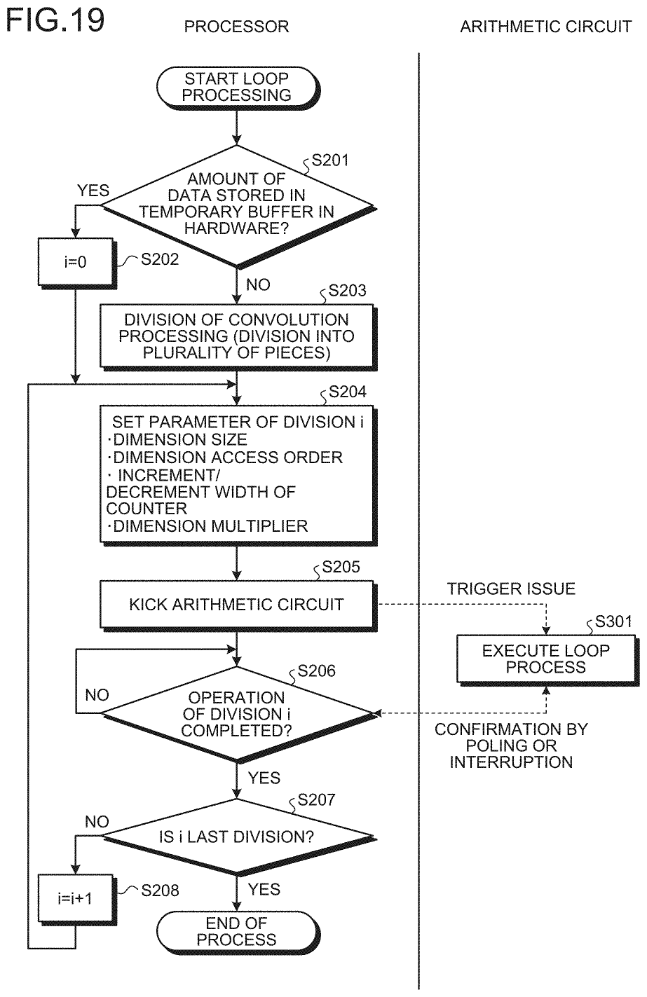

FIG. 19 illustrates an example of a control flow of software in the case of the configuration of FIG. 18. FIG. 19 is a flowchart illustrating a procedure of processing according to the second embodiment.

As illustrated in FIG. 19, in a case where the data is an amount that can be stored in the temporary buffer 182 inside the hardware (Step S201: Yes), the processor 101 sets the variable i to “0” (Step S202). That is, when the amount of data can be stored in the temporary buffer 182 inside the hardware, the processor 101 performs the following process without dividing the data.

On the other hand, when the data cannot be stored in the temporary buffer inside the hardware (Step S201: No), the processor 101 divides the convolution process (Step S203). When the data cannot be stored in the temporary buffer in the hardware, the processor 101 divides the data into a plurality of pieces (Step S203). For example, the processor 101 divides the data into (i+1) pieces (in this case, i is one or more). Then, the processor 101 sets the variable i to “0”.

Then, the processor 101 performs parameter setting for the division i (Step S204). The processor 101 performs parameter setting used for processing data of the division i corresponding to the variable i. For example, the processor 101 performs parameter setting used for processing data of division 0 corresponding to the variable 0. For example, the processor 101 sets at least one of dimension size, dimension access order, counter increment or decrement width, and dimension multiplier. For example, the processor 101 sets at least one of a parameter related to the first dimension of data of the division i, a parameter related to the second dimension of data of the division i, and a parameter related to the third dimension of data of the division i.

Then, the processor 101 kicks the arithmetic circuit 180 (Step S205). The processor 101 issues a trigger for the arithmetic circuit 180.

Then, the arithmetic circuit 180 executes loop processing in response to a request from the processor 101 (Step S301).

Then, in a case where the operation of the division i is not completed (Step S206: No), the processor 101 repeats Step S206 until the process is completed. Note that the processor 101 and the arithmetic circuit 180 may communicate until the operation of the division i is completed. The processor 101 may perform confirmation by polling or interruption with the arithmetic circuit 180.

Then, in a case where the operation of the division i is completed (Step S206: Yes), the processor 101 determines whether i is the last division (Step S207).

When i is not the last division (Step S207: No), the processor 101 adds 1 to the variable i (Step S208). Then, the processor 101 returns to Step S204 and repeats the process.

In a case where i is the last division (Step S207: Yes), the processor 101 ends the process. For example, in a case where the data is not divided, the processor 101 ends the process because the data of i=0 is the last data.

In “parameter setting of division i” in Step S204 in FIG. 19, “dimension access order” is set in advance in a register in the arithmetic circuit 180 before the arithmetic operation, so that the memory access controller 103 can access data with flexibility. As an example, the order of reading the three-dimensional data of the RGB image can be set to the width direction first, the height direction next, and the channel direction (in the expression of Table 1, in the order of W, H, and C) of RGB next in a certain recognition task. In another recognition task, the RGB channel direction may be read first, the width direction may be read next, and the height direction may be read last (in the expression of Table 1, in the order of C, W, and H).

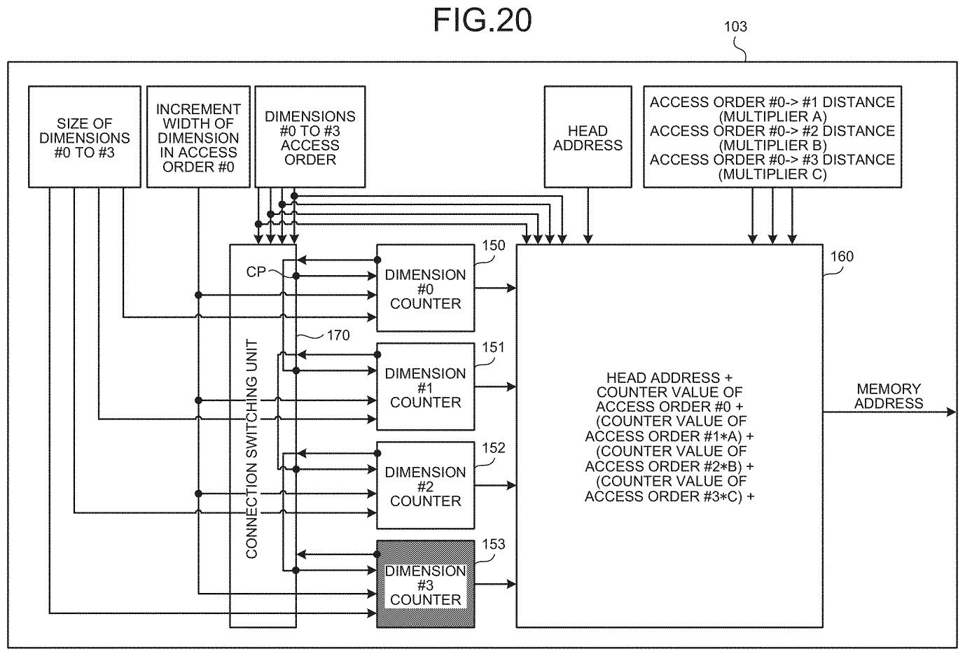

Here, an example of a control change process by the connection switching unit 170 is illustrated in FIG. 20. FIG. 20 is a diagram illustrating an example of a process according to the second embodiment. An arrow in FIG. 20 indicates a direction from a generation source to a connection destination of a physical signal line. In addition, a dotted arrow in the layout A in FIG. 21 indicates the order of reading data. FIG. 21 is a diagram illustrating an example of a memory access according to the second embodiment.

In the example of FIG. 20, since the three-dimensional data of the RGB image is the target, the address generation is performed using three counters of the dimension #0 counter 150, the dimension #1 counter 151, and the dimension #2 counter 152 without using the dimension #3 counter 153. FIG. 20 illustrates a case where the clock pulse CP is input to the dimension #0 counter 150, and the dimension #0 counter 150, the dimension #1 counter 151, the dimension #2 counter 152, and the dimension #3 counter 153 are connected in this order to the connection switching unit 170.

In a case where the dimension #0 counter 150, the dimension #1 counter 151, and the dimension #2 counter 152 in FIG. 20 corresponds to the dimensions of the width (W), the height (H), and the RGB channel (C) of the three-dimensional RGB image data, respectively, the image can be read in the order of W, H, and C. That is, in the case of the connection of the counter of the memory access controller 103 of FIG. 20, as illustrated in FIG. 21, the entire data DT11 corresponding to red (R), the entire data DT12 corresponding to green (G), and the entire data DT13 corresponding to blue (B) are accessed in this order.

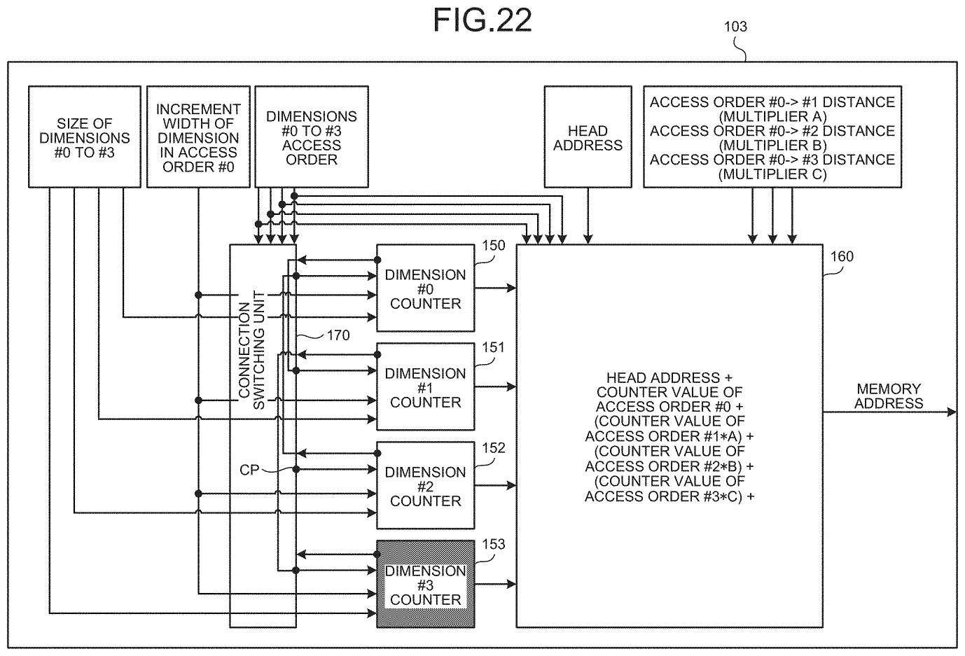

Next, another example of the control change process by the connection switching unit 170 is illustrated in FIG. 22. FIG. 22 is a diagram illustrating another example of the processing according to the second embodiment. An arrow in FIG. 22 indicates a direction from a generation source to a connection destination of a physical signal line. In addition, a dotted arrow in the layout A in FIG. 23 indicates the order of reading data. FIG. 23 is a diagram illustrating another example of the memory access according to the second embodiment.

In the example of FIG. 22, since the three-dimensional data of the RGB image is the target, the address generation is performed using three counters of the dimension #0 counter 150, the dimension #1 counter 151, and the dimension #2 counter 152 without using the dimension #3 counter 153. FIG. 22 illustrates a case where the clock pulse CP is input to the dimension #2 counter 152, and the dimension #2 counter 152, the dimension #0 counter 150, the dimension #1 counter 151, and the dimension #3 counter 153 are connected in this order to the connection switching unit 170.

In a case where the dimension #0 counter 150, the dimension #1 counter 151, and the dimension #2 counter 152 in FIG. 22 corresponds to the dimensions of the width (W), the height (H), and the RGB channel (C) of the three-dimensional RGB image data, respectively, the image can be read in the order of C, W, and H. That is, in the case of the connection of the counter of the memory access controller 103 of FIG. 22, as illustrated in FIG. 23, the first data of the data DT21 corresponding to red (R), the first data of the data DT22 corresponding to green (G), the first data of the data DT23 corresponding to blue (B), the second data of the data DT21 corresponding to red (R), . . . are accessed in this order.

As illustrated in the two examples of FIGS. 20 to 23, even in the case of the same layout A, the memory built-in device 20A can perform memory access in the different orders by changing the connection.

As described above, in the second embodiment, the memory built-in device 20A can read and write tensor data from and to the memory in any order, and can perform optimum data access to the arithmetic unit without being restricted by software or a sensor specification. As a result, the memory built-in device 20A can complete the process of the same tensor with a small number of cycles by making the most of parallelization of the arithmetic units. Therefore, the memory built-in device 20A can also contribute to power reduction of the entire system. In addition, since the address calculation of the tensor can be performed without intervention of the processor after setting the parameter once, data access can be performed with power saving.

### 2. OTHER EMBODIMENTS

The processing according to each embodiment described above may be performed in various different forms (modifications) other than the embodiments described above.

[2-1. Another Configuration Example (Image Sensor and the Like)]

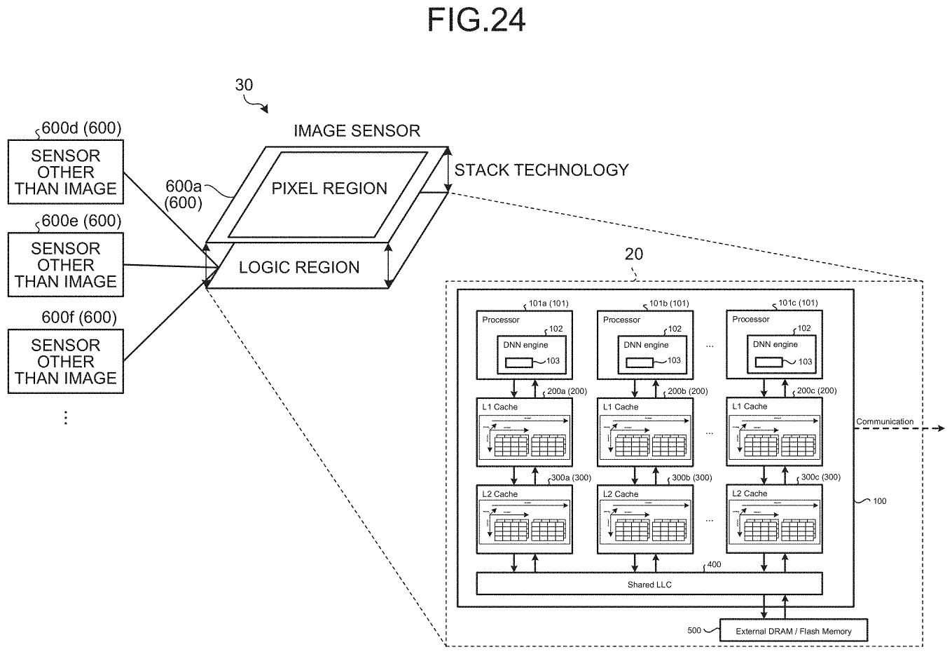

For example, the memory built-in device 20, 20A described above may be configured integrally with the sensor 600. An example of this case is illustrated in FIG. 24. FIG. 24 is a diagram illustrating an example of application to a memory stacked image sensor device. FIG. 24 illustrates an intelligent image sensor device (memory stacked image sensor device) 30 in which the image sensor 600a including an image region and the memory built-in device 20 serving as a logic region are stacked by a stacking technology. The memory built-in device 20 has a function of communicating with an external device, and can acquire data from a sensor 600 other than the image sensor 600a.

For example, it is assumed that it is mounted on an Internet of Things (IoT) sensor node that executes an AI recognition algorithm in an edge device using time-series sensor data and image sensor data to perform identification recognition and the like. Therefore, as illustrated in FIG. 24, the memory built-in devices 20 and 20A including a mounted circuit (semiconductor logic circuit) or the like are integrated with the sensor 600 such as the image sensor 600a by a stacked structure or the like, so that an intelligent sensor with low power consumption and high flexibility can be realized. The intelligent image sensor device 30 as illustrated in FIG. 24 can be adapted to environment sensing and an in-vehicle sensing solution.

[2-2. Others]

Further, it is also possible to manually perform all or part of the processing described as being performed automatically in the processing described in the above embodiment, or alternatively, it is also possible to automatically perform all or part of the processing described as being performed manually by a known method. In addition, the processing procedure, specific name, and information including various pieces of data and parameters illustrated in the above document and drawings can be arbitrarily changed unless otherwise specified. For example, the various types of information illustrated in each figure are not limited to the illustrated information.

Further, each component of each of the illustrated devices is a functional concept, and does not necessarily have to be physically configured as illustrated in the figure. That is, the specific form of distribution/integration of each device is not limited to the one illustrated in the figure, and all or part of the device can be functionally or physically distributed/integrated in any unit according to various loads and usage conditions.

Further, the above-described embodiments and modifications can be appropriately combined in a range where the processing contents do not contradict each other.

Further, the effects described in the present specification are merely examples and are not limiting, and other effects may be present.

[3. Effects According to Present Disclosure]

As described above, the memory built-in device (the memory built-in devices 20 and 20A in the embodiment) according to the present disclosure includes a processor (the processor 101 in the embodiment), a memory access controller (the memory access controller 103 in the embodiment), and a memory (in the embodiment, the first cache memory 200, the second cache memory 300, the third cache memory 400, and the memory 500) accessed according to the process by the memory access controller, wherein the memory access controller is configured to read and write data used in the operation of the convolution arithmetic circuit from and to the memory.

As a result, the memory built-in device according to the present disclosure accesses the memory such as the cache memory according to the process by the memory access controller, and reads and writes data used in the operation of the convolution arithmetic circuit from and to the memory such as the cache memory according to the process by the memory access controller, thereby enabling appropriate access to the memory.

In addition, the processor includes a convolution arithmetic circuit (the convolution arithmetic circuit 102 in the embodiment). As a result, the memory built-in device can read and write data used in the operation of the convolution arithmetic circuit in the memory built-in device from and to the memory such as the cache memory according to the process by the memory access controller, thereby enabling appropriate access to the memory.

Further, the parameter is at least one of a first parameter related to a first dimension of data before the operation or data after the operation, a second parameter related to a second dimension of data before the operation or data after the operation, a third parameter related to a third dimension of data before the operation, a fourth parameter related to a third dimension of data after the operation, and a fifth parameter related to the number of pieces of data before the operation or the number of pieces of data after the operation. As a result, the memory built-in device can enable appropriate access to the memory by identifying data to be read from or written to the memory such as the cache memory according to designation of the parameter.

The memory includes a cache memory (the first cache memory 200, the second cache memory 300, and the third cache memory 400 in the embodiment). As a result, the memory built-in device can access the cache memory according to the process by the memory access controller, thereby enabling appropriate access to the memory.

In addition, the cache memory is configured to read and write data designated using a parameter. As a result, the memory built-in device can enable appropriate access to the memory by reading and writing data designated using the parameter from and to the cache memory.

In addition, the cache memory constitutes a physical memory address space set using the parameter. As a result, the memory built-in device can access the cache memory constituting the physical memory address space set using the parameter to enable appropriate access to the memory.

The memory built-in device performs initial setting for the register corresponding to the parameter.

As a result, the memory built-in device can enable appropriate access to the memory by performing initial setting for the register corresponding to the parameter.

In addition, the convolution arithmetic circuit is used for calculating the function of the artificial intelligence. As a result, the memory built-in device can enable appropriate access to the memory for data used for calculation of the function of the artificial intelligence in the convolution arithmetic circuit.

In addition, the function of the artificial intelligence is learning or inference. As a result, the memory built-in device can enable appropriate access to the memory for data used for the calculation of the learning or inference of the artificial intelligence in the convolution arithmetic circuit.

In addition, the function of the artificial intelligence uses a deep neural network. As a result, the memory built-in device can enable appropriate access to the memory for data used for calculation using the deep neural network in the convolution arithmetic circuit.

Furthermore, the memory built-in device includes an image sensor (the image sensor 601a in the embodiment) for inputting an external image. As a result, the memory built-in device can enable appropriate access to the memory for processing using the image sensor. The image sensor is, for example, a complementary metal oxide semiconductor (CMOS) image sensor, and has a function of acquiring an image in pixel units by a large number of photodiodes.

The memory built-in device includes a communication processor that communicates with an external device via a communication network. As a result, the memory built-in device can acquire information by communicating with the outside, thereby enabling appropriate access to the memory.

An image sensor apparatus (the intelligent image sensor device 30 in the embodiment) includes a processor that provides a function of artificial intelligence, a memory access controller, a memory accessed according to a process by the memory access controller, and an image sensor. The memory access controller is configured to read and write data to be used in an operation of a convolution arithmetic circuit from and to the memory according to designation of a parameter. As a result, the image sensor device can read and write data used in the operation of the convolution arithmetic circuit such as an image captured by the image sensor device itself to and from the memory such as the cache memory according to the process by the memory access controller, thereby enabling appropriate access to the memory.

Note that the present technology may also be configured as below.
(1)
A memory built-in device comprising:
a processor;
a memory access controller; and
a memory to be accessed in accordance with a process by the memory access controller, wherein
the memory access controller is configured to read and write data to be used in an operation of a convolution arithmetic circuit from and to the memory according to designation of a parameter.
(2)
The memory built-in device according to (1), wherein the processor includes the convolution arithmetic circuit.
(3)
The memory built-in device according to (2), wherein the parameter is
at least one of a first parameter related to a first dimension of data before the operation or data after the operation, a second parameter related to a second dimension of data before the operation or data after the operation, a third parameter related to a third dimension of data before the operation, a fourth parameter related to a third dimension of data after the operation, and a fifth parameter related to the number of pieces of data before the operation or the number of pieces of data after the operation.
(4)
The memory built-in device according to (3), wherein the memory includes a cache memory.
(5)
The memory built-in device according to (4), wherein the cache memory is configured to read and write data designated using the parameter.
(6)
The memory built-in device according to (5), wherein the cache memory constitutes a physical memory address space set using the parameter.
(7)
The memory built-in device according to any one of (3) to (6), wherein
the memory built-in device performs initial setting for a register corresponding to the parameter.
(8)
The memory built-in device according to any one of (2) to (7), wherein
the convolution arithmetic circuit is used for calculating a function of artificial intelligence.
(9)
The memory built-in device according to (8), wherein the function of the artificial intelligence is learning or inference.
(10)
The memory built-in device according to (8) or (9), wherein
the function of the artificial intelligence uses a deep neural network.
(11)
The memory built-in device according to any one of (1) to (10), further comprising:
an image sensor.
(12)
The memory built-in device according to any one of (1) to (11), further comprising:
a communication processor in communication with an external device via a communication network.
(13)
A processing method comprising:
setting a register corresponding to a parameter; and
executing a program including a convolution operation having an array according to the parameter.
(14)
A parameter setting method for performing control, the method comprising:
among parameters designating data to be read from and written to a memory by a processor that reads and writes data to be used in an operation of a convolution arithmetic circuit from and to the memory,
setting at least one of a first parameter related to a first dimension of data before the operation or data after the operation, a second parameter related to a second dimension of data before the operation or data after the operation, a third parameter related to a third dimension of data before the operation, a fourth parameter related to a third dimension of data after the operation, and a fifth parameter related to the number of pieces of data before the operation or the number of pieces of data after the operation.
(15)
An image sensor device comprising:
a processor configured to provide a function of artificial intelligence;
a memory access controller;
a memory to be accessed in accordance with a process by the memory access controller; and
an image sensor, wherein
the memory access controller is configured to read and write data to be used in an operation of a convolution arithmetic circuit from and to the memory according to designation of a parameter.

### REFERENCE SIGNS LIST

10 PROCESSING SYSTEM
20, 20A MEMORY BUILT-IN DEVICE
100 ARITHMETIC DEVICE
101 PROCESSOR
102 CONVOLUTION ARITHMETIC CIRCUIT
103 MEMORY ACCESS CONTROLLER
200 FIRST CACHE MEMORY
300 SECOND CACHE MEMORY
400 THIRD CACHE MEMORY
500 MEMORY
600 SENSOR
600a IMAGE SENSOR
700 CLOUD SYSTEM

1. A memory built-in device comprising:
a processor;
a memory access controller; and
a memory to be accessed in accordance with a process by the memory access controller, wherein
the memory access controller is configured to read and write data to be used in an operation of a convolution arithmetic circuit from and to the memory according to designation of a parameter.

2. The memory built-in device according to claim 1, wherein
the processor includes the convolution arithmetic circuit.

3. The memory built-in device according to claim 2, wherein
the parameter is
at least one of a first parameter related to a first dimension of data before the operation or data after the operation, a second parameter related to a second dimension of data before the operation or data after the operation, a third parameter related to a third dimension of data before the operation, a fourth parameter related to a third dimension of data after the operation, and a fifth parameter related to the number of pieces of data before the operation or the number of pieces of data after the operation.

4. The memory built-in device according to claim 3, wherein
the memory includes a cache memory.

5. The memory built-in device according to claim 4, wherein
the cache memory is configured to read and write data designated using the parameter.

6. The memory built-in device according to claim 5, wherein
the cache memory constitutes a physical memory address space set using the parameter.

7. The memory built-in device according to claim 3, wherein
the memory built-in device performs initial setting for a register corresponding to the parameter.

8. The memory built-in device according to claim 2, wherein
the convolution arithmetic circuit is used for calculating a function of artificial intelligence.

9. The memory built-in device according to claim 8, wherein
the function of the artificial intelligence is learning or inference.

10. The memory built-in device according to claim 8, wherein
the function of the artificial intelligence uses a deep neural network.

11. The memory built-in device according to claim 1, further comprising:
an image sensor.

12. The memory built-in device according to claim 1, further comprising:
a communication processor in communication with an external device via a communication network.

13. A processing method comprising:
setting a register corresponding to a parameter; and
executing a program including a convolution operation having an array according to the parameter.

14. A parameter setting method for performing control, the method comprising:
among parameters designating data to be read from and written to a memory by a processor that reads and writes data to be used in an operation of a convolution arithmetic circuit from and to the memory,
setting at least one of a first parameter related to a first dimension of data before the operation or data after the operation, a second parameter related to a second dimension of data before the operation or data after the operation, a third parameter related to a third dimension of data before the operation, a fourth parameter related to a third dimension of data after the operation, and a fifth parameter related to the number of pieces of data before the operation or the number of pieces of data after the operation.

15. An image sensor device comprising:
a processor configured to provide a function of artificial intelligence;
a memory access controller;
a memory to be accessed in accordance with a process by the memory access controller; and
an image sensor, wherein
the memory access controller is configured to read and write data to be used in an operation of a convolution arithmetic circuit from and to the memory according to designation of a parameter.
